(19) United States
(12) Patent Application Publication
(10) Pub. No.: US 2026/0346944 A1
(43) Pub. Date: Nov. 5, 2026

(54) Mount for mounting an extension assembly and extension system comprising said mount

(71) Applicant: DECATHLON, VILLENEUVE D'ASCQ (FR)

(72) Inventor: Benoit NORDEY, VILLENEUVE-D'ASCQ (FR)

(21) Appl. No.: 19/660,314

(22) Filed: Apr. 28, 2026

(30) Foreign Application Priority Data
May 2, 2025 (FR) 2504677

(51) Int. Cl. B62K 21/12

(52) U.S. Cl. CPC B62K 21/125

(57) ABSTRACT

Mount for mounting, on the handlebar of a bike, an extension assembly comprising first and second extension supports, said mount comprising a first mount portion defining a first housing configured to receive a first part of the handlebar such as to surround at least partially said first part of the handlebar, said first mount portion additionally being configured to cooperate with the first extension support for mounting the latter on the handlebar; a second mount portion defining a second housing configured to receive a second part of the handlebar such as to surround at least partially said second part of the handlebar, said second mount portion additionally being configured to cooperate with the second extension support for mounting the latter on the handlebar; and at least one connecting portion connecting said first mount portion and said second mount portion.

### CROSS REFERENCE TO RELATED APPLICATIONS

This application claims priority to France Patent Application No. FR 25 04677 filed on May 2, 2025, the contents of which is incorporated herein by way of reference in its entirety.

### TECHNICAL FIELD

The present disclosure relates to the technical field of mounting extensions for a bike on the handlebar of said bike. A bike handlebar is generally connected to the bike frame via a handlebar stem. The assembly formed by the handlebar and stem is called a combo. Extensions, also called aero bars or triathlon bars, are accessories intended to be mounted onto a central part of a handlebar of a bike, in particular a triathlon bike. An extension assembly generally comprises two armrests intended to support a cyclist’s forearms, and two extension bars able to be gripped by the cyclist’s hands. They enable a cyclist to take up a more compact aerodynamic position in which the elbows are drawn close to each other. Extensions therefore permit an increase in travel speed while improving cyclist comfort.

The disclosure relates to a mount allowing the mounting of an extension assembly on a bike handlebar, and to an extension system comprising said mount and said extension assembly.

### PRIOR ART

An extension system is known from document US 2005/044981, comprising an extension assembly formed of two armrests and two extension bars. The system described in this document additionally comprises an extension support composed of a base part integral with the stem of the bike and a crown cooperating with the base part to surround the handlebar such as to allow mounting of the extension assembly onto said handlebar.

First, this system has the disadvantage of requiring a specific conformation of the bike stem so that it can cooperate with the crown. In other words, the extension assembly described in this document cannot be mounted on all types of bike handlebars and proves to be scarcely polyvalent.

A further disadvantage of the system in this document is that the extension support, formed by the base part integral with the stem and crown, is mounted directly onto the handlebar. Yet the bike handlebars intended to be equipped with extensions, in particular triathlon bikes, are generally made of carbon. These carbon handlebars are sensitive to scratches and deformations. Consequently, the extension support described in this prior art document risks damaging the handlebar having regard to the clamping force it applies directly thereupon.

In addition, the extension support of the system in this document is suitable for mounting extensions on a handlebar of constant circular cross-section. On the other hand, it not suitable for mounting on a handlebar of non-circular cross-section or non-constant cross-section.

### DESCRIPTION OF THE INVENTION

It is one object of the present invention to propose a mount and extension system comprising said mount to solve the aforementioned disadvantages.

For this purpose, the invention concerns a mount for mounting on a bike handlebar an extension assembly comprising a first extension support and second extension support, said mount extending in a longitudinal direction and comprising: a first mount portion defining a first housing configured to receive a first part of the handlebar such that said first mount portion at least partially surrounds said first part of the handlebar, said first mount portion additionally being configured to cooperate with the first extension support for mounting thereof on the handlebar; a second mount portion distant from the first mount portion, said second mount portion defining a second housing configured to receive a second part of the handlebar, distant from the first part of the handlebar, such that said second mount portion at least partially surrounds said second part of the handlebar, said second mount portion additionally being configured to cooperate with the second extension support for mounting thereof on the handlebar; and at least one connecting portion connecting said first mount portion and said second mount portion and extending in said longitudinal direction.

The extension assembly advantageously comprises a first extension comprising a first armrest and/or first extension bar. The first extension support is advantageously configured to support said first extension. The extension assembly advantageously comprises a second extension comprising a second armrest and/or second extension bar. The second extension support is advantageously configured to support said second extension. Without being limited thereto, the first extension support and second extension support can form one and the same part or two separate parts.

The bike handlebar advantageously extends in a main direction. The longitudinal direction of the mount advantageously coincides with the main direction of the handlebar. The handlebar advantageously comprises a first end and a second end opposite the first end. The handlebar advantageously comprises a first grip portion located at the first end of said handlebar, and a second grip portion located at the second end of said handlebar. The handlebar advantageously comprises a central portion located between the first and second ends of the handlebar. The mount is advantageously configured to cooperate with the central portion of the handlebar.

The mount is advantageously formed in a plastic material, for example in polylactic acid (PLA), acrylonitrile butadiene styrene (ABS), polyethylene terephthalate glycol (PETG) or polyamide. It is obtained with a conventional injection method but is preferably obtained with a 3D printing method.

The mount is advantageously configured to be removably mounted on the handlebar. Preferably, the first mount portion is configured removably to receive the first part of the handlebar. The second mount portion is advantageously configured removably to receive the second part of the handlebar.

The first and second mount portions of the mount are separate and distant from each other. They are separated by said connecting portion. The first and second mount portions are advantageously substantially identical.

Preferably, the first mount portion is configured to surround a first part of the handlebar located at the central portion of the handlebar. Preferably, the second mount portion is configured to surround a second part of the handlebar located at the central portion of the handlebar. Preferably, said first part of the handlebar and said second part of the handlebar are located either side of a plane of symmetry of the handlebar, which is transverse to the main direction of said handlebar.

The first mount portion and second mount portion advantageously each have an inner cross-section corresponding to the shape of the first part of the handlebar and second part of the handlebar respectively.

The first mount portion is advantageously configured to extend between the first extension support and the handlebar, when said mount and said first extension support are mounted on the handlebar. The second mount portion is advantageously configured to extend between the second extension support and the handlebar, when said mount and said second extension support are mounted on the handlebar.

Preferably, the first mount portion is configured to be at least partially surrounded by the first extension support. The first mount portion is advantageously configured to be received in a first cavity of the first extension support. Preferably, the second mount portion is configured to be at least partially surrounded by the second extension support. The second mount portion is advantageously configured to be received in a second cavity of the second extension support.

The first mount portion advantageously forms a sheath intended to receive the first part of the handlebar. The second mount portion advantageously forms a sheath intended to receive the second part of the handlebar.

The first mount portion and second mount portion are each intended to form an intermediate protective layer positioned between the handlebar and the first and second extension supports respectively. The mount therefore provides protection for the handlebar by preventing the extension supports from coming into direct contact therewith, unlike in prior art systems. The risk that the handlebar may become deformed, scratched or subject to any type of other damage related to mounting of the extension assembly is reduced. In other words, said mount forms a protective interface between the extension assembly and bike handlebar. The extension assembly is hence mounted indirectly onto the handlebar, via the mount.

The mount additionally forms an adapter allowing the extension assembly to be mounted on a handlebar having a shape that does not necessarily correspond to the shape of the cavities formed in the first and second extension supports. It therefore allows reducing of the clearance which may exist between the extension supports and the handlebar. For example, the mount allows mounting of the extension assembly on a handlebar of complex shape without damaging the latter. In particular, the mount allows the mounting of the first and second extension supports on first and second parts of the handlebar having a cross-section that is not necessarily circular e.g. of oval cross-section. In addition, the first mount portion and second mount portion also allow mounting of the first and second extension supports both onto first and second parts of the handlebar having a constant cross-section and onto handlebar parts of varying cross-section.

The mount further allows mounting of the extension assembly on all types of handlebars, without the need to modify the conformation of said handlebar or the stem of the bike, as is the case in the aforementioned prior art document wherein the stem is conformed specifically to cooperate with a crown.

The connecting portion connects the first mount portion and second mount portion. It allows the maintaining of a constant space between the first mount portion and second mount portion. Therefore, once the mount is mounted on the handlebar, the placing in cooperation of the first and second extension supports with the first and second mount portions of the mount ensures constant, precise and suitable spacing between the two extension supports, without the need for the user manually to adjust the spacing therebetween. In other words, the mount guides the user when mounting the extension assembly and ensures good relative positioning of the first and second extension supports on the handlebar.

The connecting portion advantageously forms a strip of material extending between the first mount portion and second mount portion. Preferably, the first mount portion, second mount portion and connecting portion are formed in one same material. Preferably, the first mount portion, second mount portion and connecting portion form a one-piece assembly.

The connecting portion is advantageously flexible. It advantageously permits slight movement of the first mount portion relative to the second mount portion, to facilitate mounting of the mount on the handlebar. In particular, the connecting portion advantageously allows a slight offset between a first mounting axis of the first mount portion and a second mounting axis of the second mount portion, or slight tilting between a first mounting axis of the first mount portion and a second mounting axis of the second mount portion.

Advantageously, considered in the longitudinal direction of the mount, the connecting portion is of greater length than a length of the first mount portion, preferably greater than twice the length of the first mount portion, further preferably is substantially equal to three times the length of the first mount portion.

The mount, but not limited thereto, may comprise a plurality of connecting portions connecting the first mount portion and second mount portion.

Preferably, but not limited thereto, to mount the extension assembly on the bike handlebar, the user first mounts the mount on said handlebar, such that the first mount portion surrounds the first part of the handlebar, and the second mount portion surrounds the second part of the handlebar. The user then mounts the first extension on the handlebar placing the first extension support in cooperation with the first mount portion of the mount. The first mount portion then extends between the first extension support and the first part of the handlebar. The second extension mount is also mounted on the handlebar, placing the second extension support in cooperation with the second mount portion of the mount. The second mount portion then extends between the second extension support and the second part of the handlebar.

Advantageously, the first mount portion comprises a first outer peripheral surface configured to come into contact with the first extension support, and the second mount portion comprises a second outer peripheral surface configured to come into contact with the second extension support.

Said first outer peripheral surface is advantageously configured to come into contact with an inner surface of said first extension support. Said second outer peripheral surface is advantageously configured to come into contact with an inner surface of said second extension support.

Advantageously, said first mount portion extends along a first mounting axis, and the second mount portion extends along a second mounting axis, said first and second mounting axes being substantially parallel to said longitudinal direction. The first and second mounting axes are advantageously parallel to each other. Preferably, but not limited thereto, the first mounting axis and second mounting axis are merged.

Preferably, the first housing, formed by the first mount portion, extends along said first mounting axis. Preferably, the second housing formed by the second mount portion extends along said second mounting axis. Preferably, said first and second housings extend along said longitudinal direction of the mount.

Preferably, the first mounting axis and second mounting axis merge with a main axis along which there extends said mount. Preferably, the first and second mount portions are coaxial.

Preferably, the first mount portion and/or second mount portion have a shaped profile. Preferably said first mount portion and/or second mount portion are hollow.

Preferably, said first mount portion and/or second mount portion are generally of tubular shape. It is meant thereby that the first mount portion and/or second mount portion are hollow and are of substantially constant cross-section. The tubular shape is not restricted to a cross-section of circular shape. This tubular shape allows the forming of said first and second housings. Said shape is particularly suitable to allow the first and second mount portions to surround the bike handlebar. This improves cooperation between the mount and said handlebar.

The first mount portion, but not limited thereto, may have a general cross-section of circular, oval, square or hexagonal shape. The second mount portion, but not limited thereto, can have a general cross-section of circular, oval, square or hexagonal shape.

The shape and cross-section of the first and second mount portions are advantageously chosen according to the shape of the handlebar.

Advantageously, the first mount portion and/or second mount portion have the form of a cylindrical sleeve. Preferably, the first mount portion has the form of a cylindrical sleeve extending along the first mounting axis, and the second mount portion has the form of a cylindrical sleeve extending along the second mounting axis.

Preferably, the first mount portion has an inner cross-section having a shape corresponding to the shape of the cross-section of the first part of the handlebar on which it is intended to be mounted. Preferably, the second mount portion has inner cross-section having a shape corresponding to the shape of the cross-section of the second part of the handlebar on which it is intended to be mounted.

Preferably, the first mount portion has an inner cross-section of oval or circular shape, and the first mount portion has an outer cross-section of oval or circular shape.

The inner cross-section of the first mount portion is advantageously defined by an inner surface of said first mount portion. The outer cross-section of the first mount portion is advantageously defined by an outer peripheral surface of said first mount portion.

The circular or oval shape of the inner cross-section of the first mount portion is particularly suitable for mounting onto handlebars of traditional bikes which generally have an oval or circular shape. The oval or circular shape of the outer cross-section of the first mount portion is particularly suitable to allow cooperation with a first cavity of the first extension support which is preferably also of circular or oval cross-section.

Preferably, the second mount portion has an inner cross-section of oval or circular shape, and the second mount portion has an outer cross-section of oval or circular shape.

In a first advantageous variant, the first mount portion has an inner cross-section having a shape differing from the shape of an outer cross-section of said first mount portion. The first mount portion then acts as adapter allowing the mounting of a first extension support onto a handlebar having a cross-section of shape differing from that of the cross-section of a first mounting cavity of said first extension support. As an example, the first mount portion can have an outer cross-section of oval shape to adapt to a first cavity having a cross-section of oval shape formed by the first extension support, and an inner cross-section of circular shape to adapt to a handlebar of circular cross-section. Preferably, the second mount portion has an inner cross-section having a shape differing from the shape of an outer cross-section of said second mount portion.

In one other advantageous variant, the first mount portion has an inner cross-section having a shape that is substantially the same as the shape of an outer cross-section of said first mount portion. One advantage is therefore the facilitated manufacture of the mount when the handlebar and first cavity of the first extension support, intended to receive the first mount portion, are of similar shape.

Preferably, said first mount portion extends along a first mounting axis, and a longitudinal slot extending parallel to said first mounting axis is provided along the entire length of said first mount portion, when considered along said first mounting axis. Said longitudinal slot allows deforming of the first mount portion. This longitudinal slot first allows the tube formed by the first mount portion to be opened and drawn apart, so that it is possible to engage the bike handlebar in the first housing, via said longitudinal slot. This longitudinal slot therefore facilitates mounting of the mount on the handlebar. Said longitudinal slot additionally allows clamping and closing of the first mount portion when it is subjected to a clamping force applied by the first and second extension supports. The first mount portion can then follow the contour of the handlebar conforming to the shape thereof.

The longitudinal slot advantageously defines two wings for the first mount portion which can be drawn apart. Preferably, the first mount portion is formed in a material that is sufficiently flexible to allow such drawing apart.

Said longitudinal slot, but not limited thereto, can be formed over the entire length of said mount, or solely over the length of the first mount portion.

The first mount portion advantageously has the shape of a tube or sleeve, slit longitudinally. Advantageously, the first mount portion has a C-shaped cross-section.

Advantageously, the second mount portion also has a longitudinal slot. The second mount portion advantageously has the shape of a tube or sleeve, slit longitudinally.

Preferably, the mount comprises a connecting sleeve comprising said connecting portion and connecting the first mount portion and second mount portion, a hollow being formed in said connecting sleeve such as to define said connecting portion connecting the first and second mount portions. The connecting portion forms part of the connecting sleeve. It forms the non-hollowed out part of said connecting sleeve. Said connecting portion is slightly curved or arched. The cross-section of said connecting portion forms an arch centred on a main axis of the mount. The hollow formed in said connecting sleeve allows the forming of a throughway for the stem of the bike.

Preferably, the diameter of said connecting sleeve is substantially equal to or slightly smaller than a diameter of the first mount portion.

Advantageously, the mount additionally comprises a securing bracket projecting from said connecting portion, transverse to said longitudinal direction, said securing bracket being configured to cooperate with a securing element e.g. a screw to secure the mount on the handlebar of the bike. Said securing bracket allows securing of the mount on the handlebar in a manner that avoids pivoting or sliding thereof along the handlebar. The securing of the extension assembly on the handlebar is improved. The securing bracket also allows proper positioning of the mount relative to the handlebar, and in particular the centring thereof, which indirectly ensures the proper positioning of the extensions. This proper positioning of the mount, in the event the handlebar is of varying cross-section, ensures that the first mount portion and second mount portion have an inner cross-section having a shape that is substantially the same as the parts of the handlebar on which they are to be mounted.

Said securing bracket advantageously comprises at least one through orifice configured to receive said securing element. The securing element advantageously cooperates with a securing hole formed in the handlebar e.g. a screw thread. The screw thread can be a screw thread normally intended for mounting a support for a bike cyclocomputer or GPS system.

Preferably, said securing bracket extends tangentially relative to said connecting sleeve. Preferably, said securing bracket extends from a median portion of said connecting portion such that said securing bracket is arranged to allow centring of the mount relative to the handlebar.

Advantageously, the first mount portion has an outer peripheral surface and a first side edge, the first mount portion additionally comprising at least one rib projecting from said outer peripheral surface and extending over a perimeter of said first mount portion in the vicinity of said first side edge. Said rib allows blocking of axial sliding of the first extension support relative to the first mount portion, in the longitudinal direction, in at least one direction. This allows maintained cooperation between the first extension support and the first mount portion. The first side edge is located at an end part of the first mount portion.

Preferably, the first mount portion comprises a first rib and a second rib each projecting from the outer peripheral surface of the first mount portion and distant from each other when considered in said longitudinal direction. Said first and second ribs advantageously then extend either side of the first extension support when the latter cooperates with the first mount portion. One advantage is to block sliding of the first extension support relative to the first mount portion in the longitudinal direction, in both directions.

Preferably, but not limited thereto, the second mount portion advantageously comprises at least one rib.

The invention also relates to an extension system for a bike comprising a handlebar having a first part and second part, said extension system comprising:
a mount as previously described; and
an extension assembly comprising:
   a first extension comprising a first extension bar and/or first armrest;
   a first extension support integral with the first extension, the first extension support having a first cavity intended to receive the first mount portion of the mount, for mounting said first extension onto the first part of the handlebar of the bike;
   a second extension comprising a second extension bar and/or second armrest;
   a second extension support integral with the second extension and having a second cavity intended to receive the second mount portion of the mount, for mounting said second extension onto the second part of the handlebar of the bike.

The first extension support is configured to surround the first mount portion. The second extension support is configured to surround the second mount portion. The first extension support allows mounting of the first extension onto the handlebar. The second extension support allows mounting of the second extension onto the handlebar. The first and second extension supports are advantageously substantially identical. Without being limited thereto, the first extension and second extension can be integral with each other.

The first cavity and/or second cavity are advantageously of cylindrical shape. Without being limited thereto, said first cavity can have a cross-section of circular, oval, square or hexagonal shape. The same applies to the second cavity. Preferably, the first mount portion of the mount has an outer cross-section having a shape corresponding to the shape of said first cavity. Preferably, the second mount portion of the mount has an outer cross-section having a shape corresponding to the shape of said second cavity.

Preferably, the first and second extension supports are configured to extend above the handlebar. Preferably the first and second extensions are configured to extend above the handlebar.

Preferably, said first extension support comprises a first mount base defining said first cavity, said first mount base being able to take up at least a clamping configuration wherein it fits tightly round said first mount portion. This clamping configuration allows the first extension to be held fixedly in relation to the handlebar so that it cannot pivot or slide relative to said handlebar. In this clamping configuration, the first cavity is of reduced dimensions.

Preferably, but not limited thereto, said first mount base is able to take up a rest configuration wherein it does not fit tightly round the first mount portion. One advantage is that it is possible to adjust the positioning or angle of the first extension relative to the handlebar.

Preferably, said second extension support comprises a second mount base defining said second cavity, said second mount base being able to take up at least a clamping configuration wherein it fits tightly round said second mount portion. The second mount base is advantageously substantially identical to the first mount base.

Advantageously, said first mount base comprises a main body and a clamping part cooperating with the main body, the main body and clamping part together defining said first cavity, the first mount base comprising clamping means configured to place the first mount base in the clamping configuration.

Without being limited thereto, the main body and clamping part can form one and the same part, or two separate parts. Without being limited thereto, said clamping part can be connected to the main body.

The main body advantageously has a first recess defining a first part of said first cavity. Said clamping part advantageously has a second recess defining a second part of said first cavity. Preferably, said first and second recesses are each of substantially semi-cylindrical shape.

Said clamping part is advantageously in the form of a tie or strap.

The clamping means, but not limited thereto, can be an add-on part. The clamping means advantageously cooperate with the main body and the clamping part to place the mount base in said clamping configuration.

Alternatively, the main body and/or clamping part may comprise the clamping means.

The clamping means, but not limited thereto, may comprise at least one clamping screw cooperating with the main body and with the clamping part to place the mount base in the clamping configuration. Said clamping screw then applies a clamping force on the main body and on the clamping part of the mount base. Said clamping screw also allows adjusting of the clamping force. The clamping screw advantageously cooperates with a screw thread formed in the main body or in the clamping part.

Without being limited thereto the clamping means may comprise two clamping screws.

Advantageously, the main body of the first mount base comprises a lug and said clamping part of the first mount base comprises an orifice to receive said lug such as to place the first mount base in the clamping configuration. One advantage is the facilitated mounting and dismounting of the first extension support on the bike handlebar, this action able to be achieved manually without tooling.

It will be understood that the clamping means comprise said lug and said orifice formed in the clamping part. Without departing from the scope of the invention, said clamping part could comprise said lug while said orifice could be formed in the main body.

Preferably, said first extension support additionally comprises at least one first spacer integral with said first mount base and extending between said first mount base and the first extension. This spacer allows the raising and/or inclining of the first extension relative to the handlebar. Different heights of spacer can be used to suit a cyclist’s morphology. Without being limited thereto, the first extension support may comprise a combination of different spacers and in particular one or more spacers to raise the first extension and one or more spacers to allow adjusting of the angle of the first extension relative to the handlebar.

Preferably, the first mount portion of the mount has an outer peripheral surface from which there extends a stud, the first extension support having a depression configured to receive said stud when the first cavity of the first extension support receives the first mount portion of the mount, to block rotation of the first extension support relative to said first mount portion. This allows the angle of the first extension to be maintained relative to the handlebar.

Said depression is advantageously formed in an inner surface of the first mount base. The depression is advantageously formed in the main body of the first mount base. Without departing from the scope of the invention, the depression could be formed in the outer peripheral surface of the first mount portion, while the stud could project from the first extension support.

The invention also relates to a bike comprising a handlebar having a first part and a second part, the bike additionally comprising an extension system as previously described, said mount cooperating with said handlebar such that said first mount portion at least partially surrounds said first part of the handlebar, and said second mount portion at least partially surrounds said second part of the handlebar, the first extension support cooperating with the first mount portion of the mount for mounting said first extension on the first part of the handlebar, said first mount portion extending between the first extension support and the first part of the handlebar, the second extension support cooperating with the second mount portion of the mount for mounting the second extension on the second part of the handlebar, the second mount portion extending between the second extension support and the second part of the handlebar.

Advantageously, said handlebar comprises a central portion wherein there is arranged a securing hole, the mount additionally comprises a securing bracket projecting from said connecting portion, transverse to said longitudinal direction, the bike additionally comprising a securing element e.g. a screw configured, to cooperate with the securing bracket and with said securing hole to secure said mount on the handlebar.

Said securing hole can be a hole intended for the mounting of a cyclocomputer or GPS system on the bike. The securing hole advantageously comprises a screw thread.

Advantageously, said securing bracket extends from a median portion of said connection portion such that said securing bracket is arranged to allow centring of the mount relative to the handlebar. In other words, said securing bracket extends from a portion of the connecting portion located substantially at one half of the distance separating the first and second mount portions. This median portion is located substantially equidistant from the first and second mount portions.

Preferably, the securing hole is located at a middle point of the handlebar, at equidistance from the ends of said handlebar. It is advantageously located underneath the handlebar.

### BRIEF DESCRIPTION OF THE DRAWINGS

The appended drawings are schematics intended above all to illustrate the principles of the description.

FIG. 1 is a perspective view of one embodiment of a mount according to the invention.

FIG. 2 illustrates a side view of the mount in FIG. 1.

FIG. 3 illustrates a rear view of the mount in FIG. 1.

FIG. 4 shows an extension system of the invention mounted on the handlebar of a bike, and comprising the mount in FIG. 1.

FIG. 5 is a close-up view of the extension supports of the extension system in FIG. 4.

FIG. 6 illustrates the main body and the clamping part of the first mount base of the extension system in FIG. 4.

FIG. 7 is a side cross-sectional view of the extension system in FIG. 4, with close-up on the first extension support.

### DESCRIPTION OF EMBODIMENTS

The invention relates to a mount for mounting an extension assembly onto the handlebar of a bike. The invention also relates to an extension system comprising said mount and an extension assembly intended to be mounted on said handlebar of the bike.

For the description to be more constructive, an embodiment of a mount for mounting an extension assembly, and an extension system of the invention, is described in detail below with reference to the appended drawings. It is recalled that the invention is not limited to these examples.

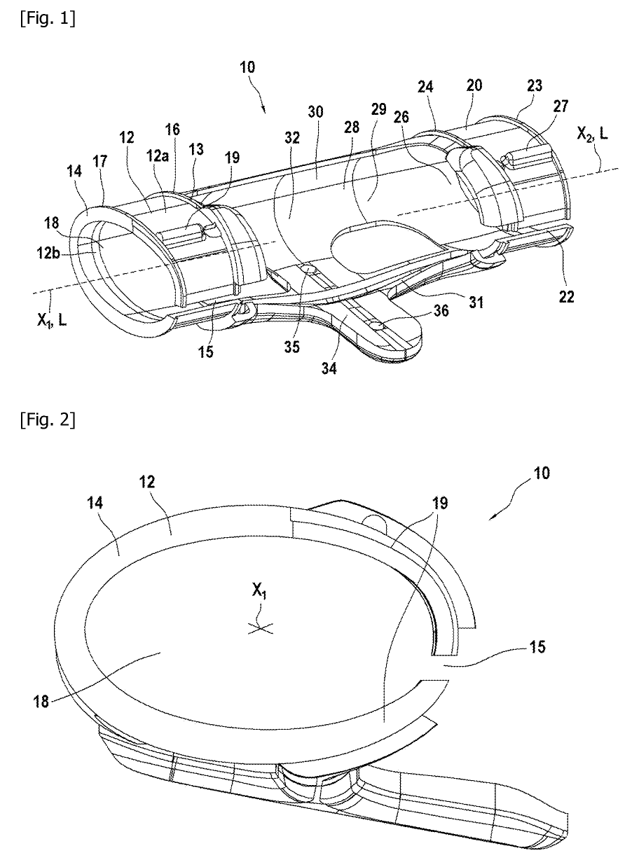

FIGS. 1 - 3 illustrate a nonlimiting embodiment of a mount 10 of the invention, for mounting an extension assembly 38 on the bike handlebar.

FIG. 1 illustrates the mount 10 from a perspective view. The mount 10 extends in a longitudinal direction L. It is formed in a rigid but slightly deformable plastic material, e.g. in polylactic acid (PLA), acrylonitrile butadiene styrene (ABS), polyamide or in polyethylene terephthalate glycol (PETG). It is obtained with a conventional injection method and preferably by 3D printing. The mount 10 comprises a first mount portion 12, a second mount portion 20, a first connecting portion 30 and a second connecting portion 31.

The first mount portion 12 has the shape of a cylindrical sleeve extending along a first mounting axis X₁ which here merges with the longitudinal direction L. In this nonlimiting example, the first mount portion 12 is of hollow tubular shape and has a generally oval cross-section corresponding to the shape of the cross-section of the handlebar C of the bike.

The first mount portion 12 has a first outer peripheral surface 12a defining a first outer cross-section for said first mount portion. This outer cross-section here is of oval shape. The first mount portion 12 additionally has an inner surface 12b defining an inner cross-section for said first mount portion. In this nonlimiting example, this inner cross-section is also of oval shape, such that the inner and outer cross-sections of the first mount portion 12 are of similar shape. Without departing from the scope of the invention, the inner and outer cross-sections of the first mount portion could have different shapes.

The first mount portion 12, and in particular the inner surface thereof, defines a first housing 18, of cylindrical shape, of oval cross-section, located inside said first mount portion. This first housing 18 is configured to receive a first part of the handlebar of the bike. It extends along the first mounting axis X₁.

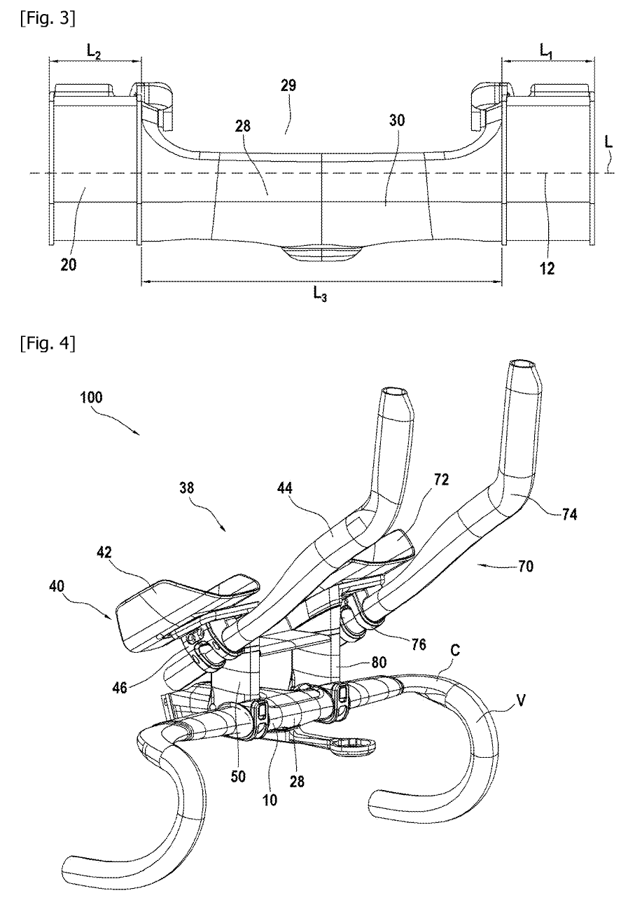

In the rear view of the mount 10 illustrated in FIG. 3, it can be seen that the first mount portion 12 has a length L₁ considered in the longitudinal direction L. The first mount portion 12 additionally has a longitudinal slot 15 that can particularly be seen in the side view in FIG. 2. This longitudinal slot 15 extends along the entire length L₁of the first mount portion, such that said first mount portion 12 forms an open sleeve. In other words, said first mount portion has a C-shaped cross-section. The longitudinal slot means that the first sleeve portion is deformable. One advantage is that it allows the sleeve to be opened and drawn apart so that it is possible to insert the handlebar in the first housing 18 via said longitudinal 15 slot. A further advantage is that it is possible to clamp and close the first mount portion 12 so that it follows the contour of the first part of the handlebar on which it is mounted.

With reference again to FIG. 1, it can be seen that the first mount portion 12 also has a first side edge 13 directed towards the second mount portion 20 and a second side edge 14 opposite the first side edge 13. A first rib 16 projects from the first outer peripheral surface 12a. This first rib 16 is positioned at the first side edge 13. The first rib 16 extends over the perimeter of the first mount portion, in a plane perpendicular to the longitudinal direction L. A second rib 17, distant from the first rib 16, also projects from the first outer peripheral surface 12a. This second rib 17 is positioned at the second side edge 14 of the first mount portion. The second rib 17 extends over the perimeter of the first mount portion in another plane perpendicular to the longitudinal direction L.

In addition, a first stud 19 projects from the first outer peripheral surface 12a of the first mount portion.

The second mount portion 20 is substantially identical to the first mount portion 12 and will therefore not be described in detail. It also has the shape of an open tube, or the shape of an open cylindrical sleeve of oval, C-shaped cross-section. It has a second outer peripheral surface and comprises a longitudinal slot 22 extending parallel to said second mounting axis X₂. In addition, this second mount portion 20 also comprises two ribs 23,24 distant from each other and projecting from said second outer peripheral surface. It comprises a second stud 27 projecting from the second outer peripheral surface.

As illustrated in FIG. 3, the second mount portion 20 has a length L₂, considered in the longitudinal direction L, substantially equal to the length L₁ of the first mount portion 12. The second mount portion 20 defines a second housing 26, of cylindrical shape located inside said second mount portion 20. This second housing 26 is configured to receive a second part C₂ of the bike handlebar.

With reference again to FIG. 1, it is seen that the mount 10 also comprises a connecting sleeve 28 connecting the first mount portion 12 and second mount portion 20. This connecting sleeve 28 is of cylindrical shape and has an oval cross-section substantially identical to the cross-section of the first and second mount portions 12,20. It extends in the longitudinal direction L. This connecting sleeve 28 has a hollow 29 defining a connecting portion 30. This connecting portion 30 connects the first mount portion 12 and second mount portion 20 and extends in the longitudinal direction L. The connecting portion 30 forms part of the connecting sleeve and is curved. It has an arch-shaped cross-section.

The connecting portion 30 has a length L₃, considered in the longitudinal direction L, which is substantially equal to three times the length L₁ of the first mount portion 12.

The connecting portion 30 has a median part 32 located at mid-distance between the first mount portion 12 and second mount portion 20. The mount comprises a securing bracket 34 extending from said median part 32 of the connecting portion. The securing bracket 34 extends transverse to the longitudinal direction L and tangentially to the connecting sleeve 28. It comprises a first through orifice 35 and a second through orifice 36 distant from each other.

The mount has a plane of symmetry perpendicular to the longitudinal direction L.

FIG. 4 illustrates a nonlimiting embodiment of an extension system 100 of the invention, comprising an extension assembly 38 mounted on the handlebar C of a bike V, and a mount 10 as illustrated in FIGS. 1 - 3.

The extension assembly 38 comprises a first extension 40 and a first extension support 50 for mounting the first extension 40 on the handlebar C of the bike V. The first extension 40 comprises a first armrest 42 and a first extension bar 44 integral with the first armrest 42. More specifically, the first extension bar 44 is fastened underneath the first armrest via a first fastening part 46. The extension assembly 38 also comprises a second extension 70 and a second extension support 80 for mounting the second extension 70 on the handlebar C of the bike V. The second extension 70 comprises a second armrest 72 and a second extension bar 74 integral with the second armrest 72. More specifically, the second extension bar 74 is fastened underneath the second armrest via a second fastening part 76.

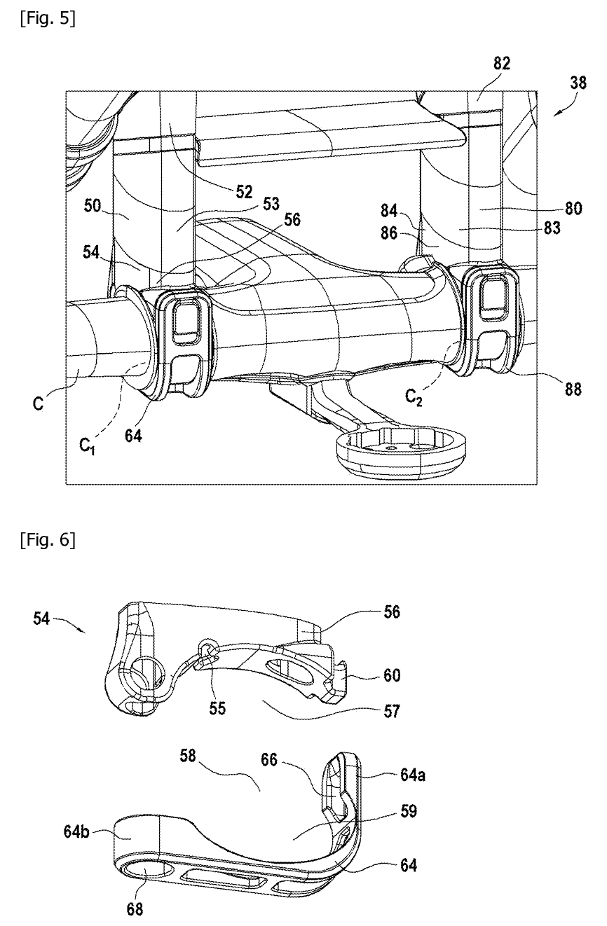

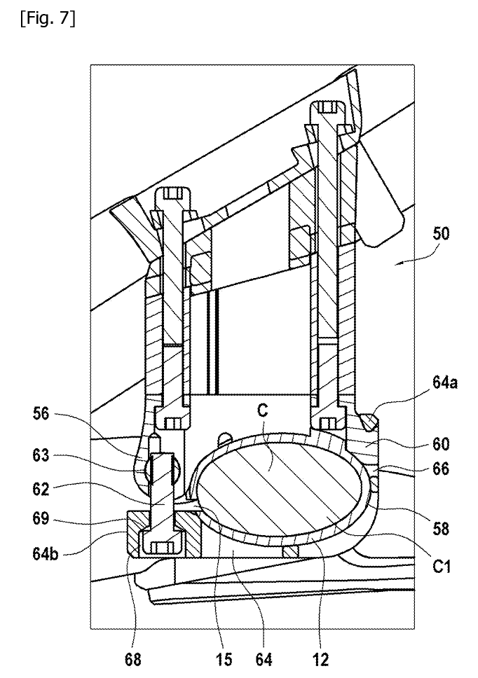

FIG. 5 is a close-up view of the first and second extension supports 50,80. In this Figure, it can be seen that the first extension support 50 comprises a first spacer 52 allowing the angle of the first extension 40 to be adjusted relative to the handlebar. The first extension support additionally comprises a second spacer 53 allowing the first extension 40 to be raised. The first spacer 52 is secured to the second spacer 53 via two screws seen in the cross-sectional view in FIG. 7. The first extension support 50 additionally comprises a first mount base 54 to which the second spacer 53 is secured via two screws. The first mount base 54 comprises a main body 56 and a clamping part 64 configured to cooperate with said main body 56.

The main body 56 and clamping part 64 of the first mount base 54 are shown individually in FIG. 6. The main body 56 is formed in aluminium material. It has the shape of a semi-sleeve. It has a first recess defining a first semicylindrical cavity part 57. The main body comprises a lug 60 at its end part. It additionally has a depression 55 formed in its inner surface configured to receive the stud 19 of the first mount portion 12 of the mount 10.

The clamping part 64 of the first mount base 54 is in the form of a tie or strap. It also has a recess defining a second semicylindrical cavity part 59. The clamping part 64 has a first end part 64a and a second end part 64b. A through orifice 66 is arranged in the first end part 64a, such that it opens into the recess formed by the clamping part. A through lumen 68 is arranged in the second end part 64b of the clamping part 64. The second end part 64b of the clamping part additionally has an inner shoulder 69 seen in the cross-sectional view of the extension system illustrated in FIG. 7.

The first extension support 50 comprises a clamping screw 62, forming clamping means received in the through lumen 68 of the clamping part 64 and having a head coming to bear upon the inner shoulder 69. The clamping screw 62 is configured to cooperate with a screw thread 63 formed in the main body 56. As can be seen in this FIG. 7, the clamping screw 62 allows assembling of the main body 56 with the clamping part 64 of the first mount base 54. The main body and clamping part of the first mount base 54 together define a first cavity 58 of cylindrical tubular shape, of oval cross-section. As can be seen in FIG. 7, the outer cross-section of the first mount portion 12 has a shape substantially identical to the shape of the cross-section of said first cavity 58.

The second extension support 80 is similar to the first extension support as can be seen in FIG. 5. It therefore also comprises a first spacer 82 and a second spacer 83. It additionally comprises a second mount base 84 to which said second spacer is secured. The second mount base 84 also comprises a main body 86 and a clamping part 88 configured to cooperate with said main body 86. The first and second extension supports 50,80 are connected together via a crossbar 90 forming a bridge between the second spacers 53,83 of said extension supports.

To mount the extension assembly 38 on the handlebar C of the bike V, the user first mounts the mount 10 on said handlebar. To do so, the first and second mount portions 12,20 are drawn apart to insert the handlebar in the first and second housings 18,26, via the longitudinal slots 15,22. The first mount portion 12 then surrounds a first part C₁ of the handlebar C. The second mount portion 20 surrounds a second part C₂ of the handlebar C distant from the first part C₁. These first and second parts C₁,C₂ of the handlebar C are located at a central portion of the handlebar, either side of a plane of symmetry for the handlebar. The inner surface 12b of the first and second mount portions 12,20 comes into contact with the handlebar and follows the contour of the latter.

The stem of the bike extends via the hollow formed in the connecting sleeve of the mount 10.

The mount 10 is secured to the handlebar by means of a securing element e.g. a securing screw. Said securing screw is placed in cooperation with the securing hole comprising a screw thread and formed underneath the handlebar C, such that it passes through the securing bracket 34 via one of the through holes 35,36. This securing prevents the mount 10 from moving relative to the handlebar while ensuring good positioning and good centring thereof relative to the handlebar C. This screw thread can be a screw thread intended for mounting a cyclocomputer or GPS system for the bike.

The user then mounts the extension assembly 38 on the handlebar placing in cooperation the first and second extension supports 50,80 with the mount 10. To do so, the user positions the first mount portion 12 of the mount in the first cavity 58 defined by the first mount base 54 of the first extension support 50. The user manually adjusts the angle of the first extension 40 with the handlebar.

When the first extension is correctly positioned, the user places the clamping part 64 of the first mount base 54 in cooperation with the main body 56 of the first mount base, such that the orifice 66 of the clamping part 64 receives the lug 60, thereby ensuring clamping of the first mount portion 12. The first mount base 54 is then in a clamping configuration wherein it tightly surrounds said first mount portion 12 and indirectly the first part C₁ of the handlebar C. The first clamping portion 12 extends between the first part C₁ of the handlebar and the first mount base 54 of the first extension support 50.

The first mount base then cooperates with a part of the first mount portion 12 positioned between the first and second ribs 16,17, such as to prevent sliding of the first extension support 50 in relation to the handlebar. In addition, the depression 55 formed in the main body 56 of the first mount base 54 receives the stud 19 of the first mount portion 12 of the mount, to block pivoting of the first extension support 50 in relation to the handlebar. The first extension support 50 and therefore the first extension 40, are then fixed relative to the handlebar.

The user repeats these same operations to secure the second extension support 80 and therefore the second extension 70 on the second part C₂ of the handlebar C. The second mount base 84 is then in a clamping configuration wherein it tightly surrounds said second mount portion 20 and indirectly the second part C₂ of the handlebar C. The second clamping portion 20 then extends between the second part C₂ of the handlebar and the second mount base 84 of the second extension support 80. The two extensions 40,70 are then secured and centred relative to the handlebar as illustrated in FIG. 4. The mount 10 of the invention then forms an intermediate part affording protection for the handlebar, preventing the first extension support 50 and second extension support 80 from coming into direct contact with said handlebar.

The extension assembly 38 can be dismounted from the handlebar by applying a force on the clamping parts 64,88 of the first and second mount bases 54,84, to extract the lugs 60 from the orifices 66. The first and second mount bases are then in a rest configuration wherein they do not clamp the first and second mount portions 12,20. The extension supports 50,80 can then be dismounted. The cooperation between the mount 10 and handlebar C can then be discontinued by also dismounting the first and second mount portions 12,20 from the handlebar via the longitudinal slots 15,22.

1. A mount, for mounting on the handlebar of a bike, an extension assembly comprising a first extension support and a second extension support, said mount extending in a longitudinal direction and comprising:
a first mount portion defining a first housing configured to receive a first part of the handlebar such that said first mount portion at least partially surrounds said first part of the handlebar, said first mount portion additionally being configured to cooperate with the first extension support for mounting the latter on the handlebar;
a second mount portion distant from the first mount portion, said second mount portion defining a second housing configured to receive a second part of the handlebar, distant from the first part of the handlebar, such that said second mount portion at least partially surrounds said second part of the handlebar, said second mount portion additionally being configured to cooperate with the second extension support for mounting the latter on the handlebar; and
at least one connecting portion connecting said first mount portion and said second mount portion, and extending in said longitudinal direction.

2. The mount according to claim 1, wherein the first mount portion comprises a first outer peripheral surface configured to come into contact with the first extension support, and wherein the second mount portion comprises a second outer peripheral surface configured to come into contact with the second extension support.

3. The mount according to claim 1, wherein said first mount portion extends along a first mounting axis, and wherein the second mount portion extends along a second mounting axis, said first and second mounting axes being substantially parallel to said longitudinal direction.

4. The mount according to claim 1, wherein said first mount portion and/or the second mount portion are of general tubular shape.

5. The mount according to claim 4, wherein the first mount portion has an inner cross-section of oval or circular shape, and wherein the first mount portion has an outer cross-section of oval or circular shape.

6. The mount according to claim 4, wherein the first mount portion has an inner cross-section having a shape differing from the shape of an outer cross-section of said first mount portion.

7. The mount according to claim 4, wherein said first mount portion extends along a first mounting axis and wherein a longitudinal slot, extending parallel to said first mounting axis, is arranged over the entire length of said first mount portion, considered along said first mounting axis.

8. The mount according to any of claim 1, comprising a connecting sleeve comprising said connecting portion and connecting the first mount portion and second mount portion, a hollow being arranged in said connecting sleeve such as to define said connecting portion connecting the first and second mount portions.

9. The mount according to claim 1, additionally comprising a securing bracket projecting from said connecting portion, transverse to said longitudinal direction, said securing bracket being configured to cooperate with a securing element e.g. a screw for securing the mount on the handlebar of the bike.

10. The mount according to claim 1, wherein the first mount portion has an outer peripheral surface and a first side edge, the first mount potion additionally comprising at least one rib projecting from said outer peripheral surface and extending over a perimeter of said first mount portion in the vicinity of said first side edge.

11. An extension system for a bike comprising a handlebar having a first part and a second part, said extension system comprising:
a mount according to claim 1; and
an extension assembly comprising:
a first extension comprising a first extension bar and/or a first armrest; a first extension support integral with the first extension, the first extension support having a first cavity intended to receive the first mount portion of the mount for mounting said first extension on the first part of the handlebar of the bike;
a second extension comprising a second extension bar and/or a second armrest; and
a second extension support integral with the second extension and having a second cavity intended to receive the second mount portion of the mount for mounting said second extension on the second part of the handlebar of the bike.

12. The extension system according to claim 11, wherein said first extension support comprises a first mount base defining said first cavity, said first mount base being able to take up at least one clamping configuration wherein it fits tightly round said first mount portion.

13. The extension system according to claim 12, wherein said first mount base comprises a main body and a clamping part cooperating with the main body, the main body and clamping part together defining said first cavity, the first mount base comprising clamping means configured to place the first mount base in the clamping configuration.

14. The extension system according to claim 13, wherein the main body of the first mount base comprises a lug and wherein said clamping part of the first mount base comprises an orifice configured to receive said lug such as to place the first mount base in the clamping configuration.

15. The extension system according to claim 12, wherein said first extension support additionally comprises at least one first spacer integral with said first mount base and extending between said first mount base and the first extension.

16. The extension system according to claim 11, wherein the first mount portion of the mount has an outer peripheral surface from which there projects a stud, the first extension support having a depression configured to receive said stud when the first cavity of the first extension support receives the first mount portion of the mount, to block rotation of the first extension support relative to said first mount portion.

17. A bike comprising a handlebar having a first part and a second part, the bike additionally comprising an extension system according to claim 11, said mount cooperating with said handlebar such that said first mount portion at least partially surrounds said first part of the handlebar, and said second mount portion at least partially surrounds said second part of the handlebar, the first extension support cooperating with the first mount portion of the mount for mounting said first extension on the first part of the handlebar, said first mount portion extending between the first extension support and the first part of the handlebar, the second extension support cooperating with the second mount portion of the mount for mounting the second extension on the second part of the handlebar, said second mount portion extending between the second extension support and the second part of the handlebar.

18. The bike according to claim 17, wherein said handlebar comprises a central portion in which a securing hole is arranged, wherein the mount additionally comprises a securing bracket projecting from said connecting portion, transverse to said longitudinal direction, the bike additionally comprising a securing element e.g. a screw configured to cooperate with the securing bracket and with said securing hole to secure said mount on the handlebar.

19. The bike according to claim 18, wherein the securing bracket extends from a median portion of said connecting portion such that said securing bracket is arranged to allow centring of the mount relative to the handlebar.
